(19) United States
(12) Patent Application Publication
(10) Pub. No.: US 2008/0235157 A1
(43) Pub. Date: Sep. 25, 2008

(54) Method, System and Program Product for a Where-Used Costing Analysis

(75) Inventor: Phillip E. Frazier, Owensboro, KY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, ARMONK, NY (US)

(21) Appl. No.: 11/688,268

(22) Filed: Mar. 20, 2007

(51) Int. Cl. G06G 7/00

(52) U.S. Cl. 705/400

(57) ABSTRACT

A method, system and program product for allowing an end user of a costing process to analyze assemblies in a manufacturing process which use common technology or parts. A computer database is maintained for storing bills of materials for manufacturing assemblies. A part is selected which is common to one or more manufacturing assemblies. Using where-used cost logic, the where-used cost of the selected part in the bills of materials is determined to provide the cost of the selected part where used in said manufacturing assemblies. The where-used costs are provided to the user for approval. The bills of materials are updated in the database with approved where-used costs of the selected part.

### FIELD OF THE INVENTION

This invention relates to a method, system and program product for analyzing assembly and component cost changes where a common part changes, and particularly to an analysis where a Where-Used costing procedure is used.

### BACKGROUND OF THE INVENTION

Excessive manual work is involved when setting standard costs for assemblies when one common component cost changes. Because the part is used in many assemblies then all of the assembly costs must change. Otherwise, variances are created. This will be especially true when products, driven by technology convergence, are changed and simplified creating more and more common parts. Currently, when a high dollar component changes costs due to an engineering change between cost setting quarter points, costs may need to be changed. When costs are changed this also causes an inventory revaluation. This is part of industry accepted practices when using the standard costing process. When this does occur, all work associated with the cost change is manual, analyzing one assembly at a time and then changing the cost one assembly at a time. This is not acceptable in a high volume environment where common parts usage is becoming more and more prevalent. In addition, when the future direction is to converge technology between major product lines, this problem becomes worse and a “Where-Used” standard costing is a high volume solution. This small piece meal approach is what major ERP (Enterprise Resource Planning) products do today (e.g. SAP (Standard Application Programs), MAPICS (Manufacturing Accounting Production Information Control System). A “Where-Used” standard costing process automates the manual work.

As businesses drive towards technology convergence tools are needed to help innovate, reduce current finance work as well as to avoid future finance workload increases. The benefits of this type of tool not found in SAP (Standard Application Programs) and our other major ERP (Enterprise Resource Planning) system, MAPICS (Manufacturing Accounting Production Information Control System) include: promoting speed and accuracy in the costing process moving it towards an on-demand process, workload elimination and avoidance providing more value to customers by reduction of costs and elimination of costs, best of Breed Idea not used in other major ERP (Enterprise Resource Planning) packages, further improves standard costing processes, more responsive to management on-demand requests, and provides indefinite benefits and payback as long as standard costing is the cost methodology of a company.

### SUMMARY OF THE INVENTION

It is a primary object of the present invention to provide a “Where-Used Standard Costing Process” which allows the financial end user to find assemblies which use the new common technology part, create an automated analysis process with several input parameters and update the costs automatically in mass after management approval.

It is another object of the present invention to provide a revaluated inventory accounting entry where appropriate which is an industry accepted standard cost practice, thus avoiding the current business process of manually creating a single entry analysis for each assembly and then creating a small group of entries for update.

It is another object of the present invention to provide an automated “Where-Used Costing” process for standard cost updates. When a corporate laboratory or a customer laboratory releases a new common part/component due to technology convergence or product simplification, the assembly bill of materials requires analysis for a potential cost update for the component and the assembly. The “Where-Used Cost Process” reduces drastically the time a cost analyst requires in order to analyze inventory cost changes and possible future variance creation and go right to update decisions and approvals.

It is another object of the present invention to provide a system wherein, when a technology simplification or collapse occurs and common parts are increased such that a component with the same part number is used in numerous assemblies, the costs of a new component is recalculated in a rapid and timely basis. If this recalculation of costs does not occur on a rapid and timely basis in a high volume technology converging environment, then unacceptable standard costing variances may be incurred which require an inordinate period of time to reabsorb over future product shipments. As new product life cycles become converged and shortened this further exacerbates the problem. Many times this situation can occur in the middle of quarter, e.g. in February or March where the standard costing quarter typically starts in January and ends in December. If this occurs, instead of researching each individual cost, the cost analyst can reset the cost on all assemblies using the part or some sub section of assemblies using the part. After the selection is made, then the costs of all of the assemblies can be “rerolled” or “recosted” using the “where-used costing process”.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a computer system of the present invention;

FIG. 2 forms a flowchart of one embodiment of the invention; and

FIGS. 3 and 4, taken together, form a flowchart of another embodiment of the invention.

The detailed description explains the preferred embodiments of the invention, together with advantages and features, by way of example with reference to the drawings.

### DETAILED DESCRIPTION OF THE INVENTION

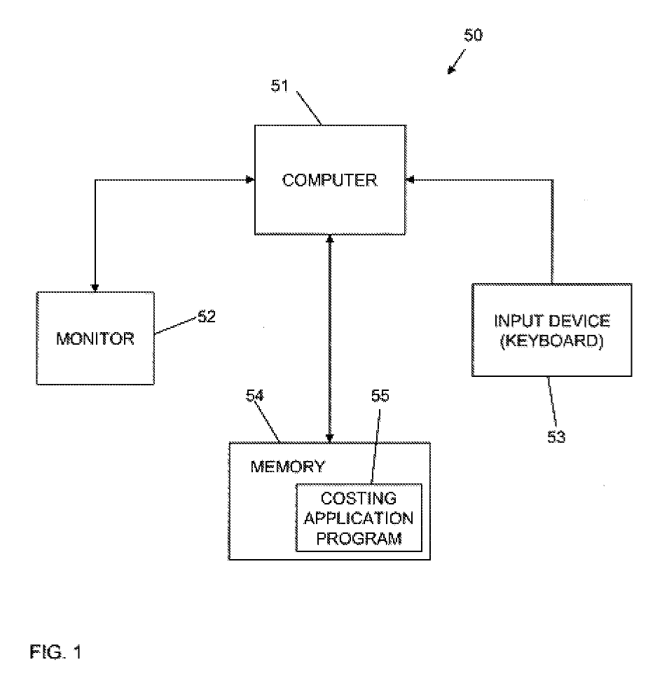

FIG. 1 is a schematic drawing of a computer system 50 having a computer 51, a monitor 52, and an input device 53 such as a keyboard or a diskette or compact disk (CD) reader. The computer system also includes a memory 54 in which is stored one or more application programs 55 for execution by the computer 51. As will be explained later, the application program 55 may be a program of computer readable program code or may be a combination of computer programs used in combination with, for instance, a spreadsheet program such as Excel available from Microsoft Corp. The computer system 50 may also include peripheral devices such as printers, disk drive devices, etc. The computer 51 may be a single computer or a network of computers, as is well known in the art, and will not be explained further.

In one embodiment, a laboratory releases a new part to converge and collapse technology or simplify the product. The laboratory release of the new part causes many assembly changes across the business, logistically and financially. This is due to the fact the new simplified common part is now used in many assemblies. In a similar way, development engineering releases new, unusually large amounts of assembly bill of materials in order to accommodate the technology convergence. Laboratories are typically driven by market demands and not financial costing processes. In order to satisfy customer on-demand needs, companies are customer driven and the value-added processes of a company, like product costing with standard costing, are needed in order to correctly cost the products of the business, state the inventory and the balance sheet correctly for product development and costing. Such costing analysis is industry practice and may be additional driven by accounting guidelines as well as legal requirements such as Sarbanes-Oxley.

The new part must have a cost set. Most cost sets are procured or purchased costs as the technology becomes cheaper, standardized and are set by a supplier. The cost for the single component is set. Many of today's ERP (Enterprise Resource Planning) systems offer finance no where-used capability analysis with associated dollars in order to quickly evaluate product structure changes when it comes to financial product costing. By using a “Where-Used Costing Process” this would allow users of the standard cost methodology to reset the standard cost of the new technology component business as usual, but goes beyond existing capabilities and allows for where-used analysis for all assemblies that use the new component and for setting the new standard cost for the assemblies that use the new component. A cost process is provided that does a where-used analysis against the engineering bill of material and then costs the bill of material.

Once the technology is collapsed or begins to collapse there may be 10-15 assemblies that use a part whereas before there were only 3-5 assemblies that used the part. The complex nature of CHW (Complex Configured Hardware) products with their feature codes, MES's (Miscellaneous Equipment Specifications), field service support demands, end-of-life product support, etc., all drive the need for a faster cheaper means for finance cost departments to quickly reset standards on these assemblies already in stock. Once the new component and the new standard are initially set, then the next component change driven from a development or manufacturing engineering change will cause the process to reoccur over and over. Now however, the number of bills of material to be maintained due to simplified component technology has increased. Also, as the technology cost trends downward during increasingly shortened product life cycles, the need for these changes becomes more acute.

If these costs are not changed on a timely basis then the difference between the current lower cost of the component part and all of the assemblies where it is used becomes greater, waiting on the next quarter point standard cost roll. Standard costs are traditionally changed on a quarterly basis is to allow for more stable costing. However, if the current cost is not adopted and the difference between the current cost of the component and the new future cost of the assembly becomes greater (since the standard cost of the assembly is not altered) significant standard cost variances begin to occur.

Today, the analysis of this variance is done manually one assembly at a time on an assembly by assembly basis. Dollars savings are provided with the where-used selection criteria associated with its function, to provide a suspense file for approval and, once approved, to provide an automatic batch-update. These functions are not provided in advanced ERP (Enterprise Resource Planning) products like MAPICS (Manufacturing Accounting Production Information Control System) and SAP (Standard Application Programs).

Also provided is a way to eliminate the manual costing by cost analysts when many assemblies need a component cost change in-between quarterly cost runs.

Where-used costing, suspense files and batch update capabilities are also provided. Many known ERP (Enterprise Resource Planning) packages allow their costs to be updated with mini-runs with assemblies, but there is no analysis capability inherent with the current where-used capability.

When a new component is placed into the where used logic, the component is first searched for in all of the bills of material where the component is used. This is true if the component part is a “prime” part or a “substitute” part. This where-used ability exists in many ERP logistics packages today. However, in the present invention dollars tied to the where-used analysis and financial selection criteria on the where-used analysis is provided.

The present invention provides finance selection criteria. The existing inventory is valued in different ways so that the impact of cost changes can be readily and quickly reviewed. Options are based around what is already in the inventory and what the “projected” build variance might be. If all inventory is selected, both current and obsolete inventory, then reports access the inventory, no matter what the status is, and summarizes the dollar amount of all of the assemblies where the new component is used. This is done by comparing the old current cost to the new updated cost if the bill of material was recosted.

If only active inventory is selected, the obsolete inventory is ignored. The material master is read and if there are assemblies in stock that are not to be reworked and they are obsolete, then their costs will not change based on the “where-used” costing. By selecting the obsolete inventory only, management sees the affect of the assembly cost change even if the inventory has been marked obsolete. The decision may be made to recost the obsolete inventory since the new component caused this inventory revaluation. The reason this visibility is needed is that companies often accrue for obsolete inventory on their ledgers. This gives visibility to alterations that may be required for previous journals written to the ledger.

By selecting assemblies where the cost revaluation exceeds a variable, (for instance, the user sets this to $10,000 and the system selects assemblies for cost changes where the total change was greater than or less than $10,000) allowing financial users to assess “material” cost changes which are important to cost accounting practices and accounting instructions.

By selecting where-used sorting, the report can be created and sorted by different sorts, for instance high dollar for all inventories, high dollar by obsolete, profit centers/product codes, etc. As the business drives to more component commonality, which brand is driving the excess inventory as well as which brands costs need to be changed when setting standard costs is demonstrated.

By entering projected inventory build number (future Materials Requirements Planning (MRP)) demands, the current quarter build estimate from MRP (Materials Requirements Planning) is found. It can then be determined how many of the assemblies using the new part are currently scheduled to be manufactured in some time period for example the next 90 days. This provides that the quantity of the assembly to be manufactured to be multiplied by the difference between the assemblies current cost and the new suggested cost change. This mathematical computation is the “possible variance” to be incurred if the standard cost of the assembly is not changed.

For example, all of the assemblies that have the part in it that requires a cost change and compare to the past builds (user variable input 1 month, 2 months, 3 months) and calculate the projected variance. Thus, if the component costs $10,000 and the cost is changing to $500, then there is a $500 difference. If the cost is left unchanged, based on last months volumes of 1,100 assemblies built, a $550,000 variance will be incurred if the build rate stays flat for the following month. By searching the MRP records and looking at the next 90 days of projected builds, then this figure can be calculated for this point in time. This figure is calculated for each assembly where the high dollar part is used.

The user now can review and analyze the system suggested changes. The user can discard the entire report, alter the suggestions due to analysis or request manager immediate management approval. In the first two cases the report can be rerun for management approval since the new process holds the recommended changes in suspense. This is not industry practice and this is also part of the invention.

If the manager rejects just one assembly, then this can be rejected from the suspense file and the report rerun for final manager approval. If the manager approves the report then the final cost update can be performed.

FIG. 1 is a flowchart of the method of the present invention. At 60, a problem is determined with an identified part. The problem may be that the cost of the part has changed, a later update of the part may be substituted into assembles, or other needs which may require the “recosting” of the bills of materials containing the identified part. At 62, the user requests an updated cost using the where-used cost analysis. At 64, the where-used analysis is loaded with the part/component number and other user supplied variables such as unit cost, delivery dates, report windows, among others. At 66, the where-used logic finds assemblies with the identified part from, for instance, the part number supplied at 64. The bills of material 68 may be kept in a computer file which may be searched using known search techniques illustrated at 69. When all bills of material have been identified, the program returns at 70, and the costs of the bills of material containing the identified part is returned using the where-used analysis at 72. At 74, the user requests a review of the where-used costs. At 76 the user evaluates the results, and may request additional costs be returned using costs for components and assemblies for standard cost files 78 and MRP data 80. At the end of user evaluation at 76, the user generates reports 82 which are presented to management at 84 for approval. If management approves at 84, the costs are updated at 86. If manage does not approve at 84, the analysis may be discarded or altered at 88, and the user may request a new where-used cost study at 62.

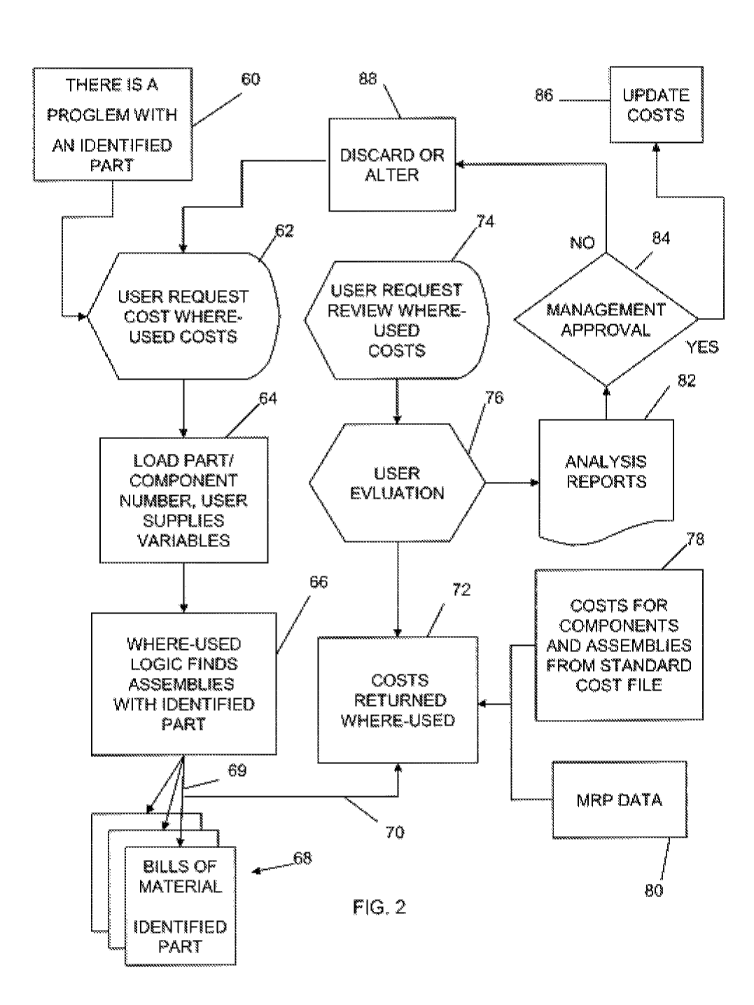

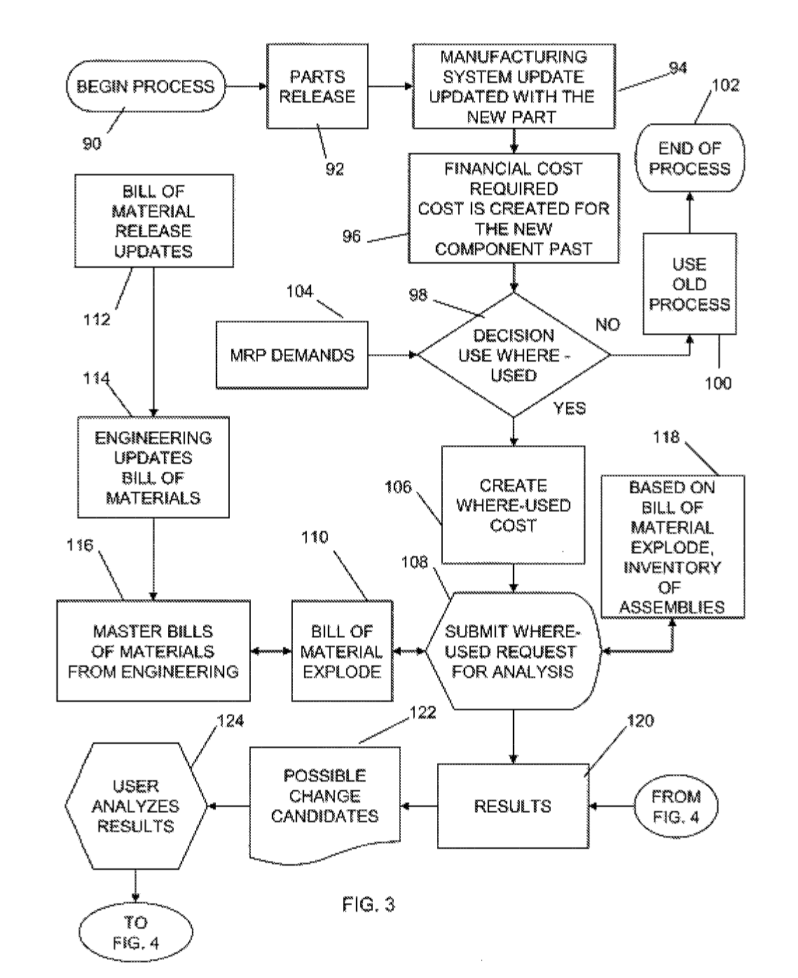

FIGS. 2 and 3, when taken together, provide a flowchart of the where-used costing process wherein the process starts at 90. At 92, the development lab, for instance, releases a new part. This may include a common component information release. It will be understood that this might include a lab process or a manufacturing or manufacturing/engineering process. At 94, the manufacturing systems update is updated with the new part, generally for the product manager. This includes the finance cost required for the new component and new assembly. Setting the cost for a new component is one basic cost update. If the part is used in many assemblies, then many assembly costs are required to be updated. Companies who are driving technology convergence need tools to drive cost convergence.

At 96, financial cost required is determined. The cost is created for the new component part. At 98, a decision to use where-used analysis is made. If at 98 the decision is no, the old process 100 is used and the process is ended at 102. At 100, the existing assembly cost creation is used to “reroll” the bill of material cost for all assemblies or selected assemblies. At this point in the process, there is not a huge impact on the inventory process; generally no new standard of cost is set. If the cost of the assembly, however, is deemed to be significantly lower and inventory costs are not changed, then the standard cost variance created can become significant. The process is also entered at 104 by entering MRP demands into the decision point 98. These MRP demands might be because of the replacement of assemblies, subassemblies, component parts, etc. caused by new pricing, replacement because of new or changed technology or other demands which changes costs or composition. Such MRP demands might also be required for manufacturing reasons such as safety changes in a product.

If the decision at 98 is yes, the where-used cost is created at 106. At 106, various cost change validations is selected. All inventory may be selected which breaks all inventory, both current and obsolete inventory, by category. Only current inventory may alternately be selected where no obsolete inventory is included. Also, only obsolete inventory may be selected wherein only obsolete inventory is costed, and current inventory is not included. Windows may also be selected wherein only user sets where the total change was greater than or less than a given amount may be selected. Where used sorting or projected inventory build number (future MRP Enterprise Resource Planning) demands may be selected to calculate possible variance. If the decision is made to conduct where-used analysis based on inventory value of projected use, then the cost will be changed. Inventory analysis allows the cost used to see the impact change based on the component cost change all across the inventory at this time, and not just at quarter points.

At 108, the where-used request is submitted for analysis. Based on the selections made in 106, the analysis may be made on inventory turns, all inventory, active inventory only, or obsolete inventory only. At 110, the bills of material explode is requested, made and returned.

At 112, the bills of material release updates are made. For instance, the development lab releases updated product bills of material that utilize the new part. At 114, engineering updates the bills of materials for the new assembly. Then at 116, the master bills of material from engineering are maintained in a master file. The component cost being changed accesses all of the bills of material to see where this component is used. The many ERP (Enterprise Resource Planning) systems such as SAP and MAPICS (Manufacturing Accounting Production Information Control System), COPICS (Communication Oriented Production Information Control System), there is a where-used logistics find to see what assemblies use a component. The master file 116 is there the bills of material explode 110 is requested and returned.

At 118, based on the bills of material explode, an inventory review is conducted to search the inventory by assemblies where the component where-used parts is found in an assembly in stock. The request is made and returned to analysis at 108. The inventory of assemblies may be made with component and dollar amounts, or with component with no dollar amounts, as desired.

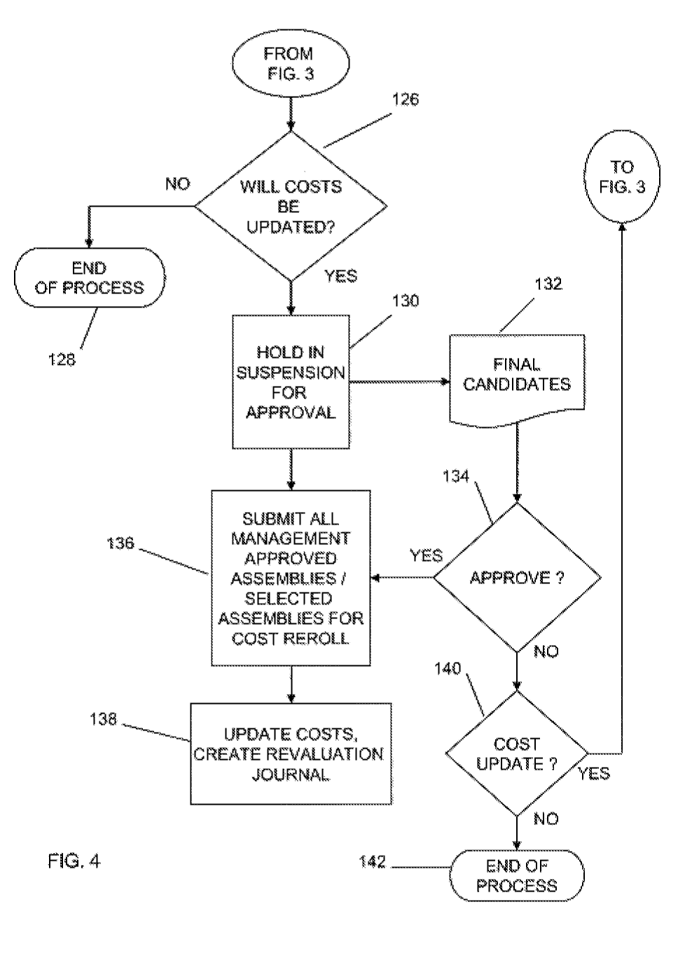

At 120, the results are listed by assemblies and dollars, if requested. At 122, possible change candidates are identified, and dollar amount reports are created. At 124, the user analyzes the results and makes a report. Going from 124 in FIG. 3 to 126 in FIG. 4, the user determines if costs will be updated. If no, the results are discarded and the process ends at 128. If yes at 126, the results are held in suspension at 130 for approval. Final candidates are selected at 132. These are candidates for change for management approval. At 134, the changed candidates are submitted to management for approval. This can be used, for instance, as a Sarbanes-Oxley control point. If the changes are approved at 134, the results in suspension at 130 are retrieved and at 136, all management approved assemblies and selected assemblies are submitted for cost reroll. At 138, costs are updated and a reevaluation journal is created.

If at 134, there is no management approval, as decision is made at 140 whether there is to be a further cost update. If no at 140, the process ends at 142. If yes, the process returns to 120 of FIG. 3 to examine the results and to selected possible change candidates at 122 as previously described.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to there diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for allowing an end user of a costing process to analyze assemblies in a manufacturing process which use common technology or parts comprising:
maintaining in a computer database, bills of materials for manufacturing assemblies;
selecting a part which is common to one or more manufacturing assemblies;
using where-used cost logic in a processor to find the where-used cost of said selected part in the bills of materials in said computer database to provide the cost of the selected part where used in said manufacturing assemblies;
providing said where-used costs for approval; and
updating said bills of materials in said database with approved where-used costs of said selected part.

2. The method according to claim 1 wherein said selecting of said part is in conjunction with an engineering change in an assembly in said manufacturing process.

3. The method according to claim 1 wherein said selecting of said part is in conjunction with the releasing of said part into said manufacturing process.

4. The method according to claim 1 wherein said selecting of said part is in conjunction with finance required standard costs for components in said manufacturing process.

5. The method according to claim 1 wherein said selecting of said part comprises selecting said part because of Materials Requirement Planning demands.

6. The method according to claim 5 wherein said Materials Requirement Planning includes safety changes in a product.

7. The method according to claim 1 further comprising holding said updating in a suspension file in said data processing system until said where-used costs are approved.

8. A system for allowing an end user of a costing process to analyze assemblies in a manufacturing process which use common technology or parts comprising:
a computer database for maintaining bills of materials for manufacturing assemblies;
an input for inputting into a where-used cost program, a selected part which is common to one or more manufacturing assemblies;
a processor for executing where-used cost logic to find the where-used cost of said selected part in the bills of materials in said computer database to provide the cost of the selected part where used in said manufacturing assemblies;
a suspension file in said computer database for holding said where-used costs until after approval; and
an updating routine for updating said bills of materials in said database with approved where-used costs of said selected part.

9. The system according to claim 8 wherein said selected part inputted into said input is selected in conjunction with an engineering change in an assembly in said manufacturing process.

10. The system according to claim 8 wherein said selected part inputted into said input is selected in conjunction with the releasing of said part into said manufacturing process.

11. The system according to claim 8 wherein said selected part inputted into said input is selected in conjunction with finance required standard costs for components in said manufacturing process.

12. The system according to claim 8 wherein said selecting of said part comprises selecting said part because of Materials Requirement Planning demands.

13. The system according to claim 12 wherein said Materials Requirement Planning includes safety changes in a product.

14. A program product for allowing an end user of a costing process to analyze assemblies in a manufacturing process which use common technology or parts comprising:
a computer readable medium having recorded thereon computer readable program code performing the method comprising:
maintaining in a computer database, bills of materials for manufacturing assemblies;
inputting into said program product, a selected part which is common to one or more manufacturing assemblies;
using where-used cost logic in a processor to find the where-used cost of said selected part in the bills of materials in said computer database to provide the cost of the selected part where used in said manufacturing assemblies;
providing said where-used costs for approval; and
updating said bills of materials in said database with approved where-used costs of said selected part.

15. The program product according to claim 14 wherein said method comprises selecting of said part is in conjunction with an engineering change in an assembly in said manufacturing process.

16. The program product according to claim 14 wherein said method comprises selecting of said part is in conjunction with the releasing of said part into said manufacturing process.

17. The program product according to claim 14 wherein said method comprises selecting of said part is in conjunction with finance required standard costs for components in said manufacturing process.

18. The program product according to claim 14 wherein said method comprises selecting of said part comprises selecting said part because of Materials Requirement Planning demands.

19. The program product according to claim 18 wherein said Materials Requirement Planning includes safety changes in a product.

20. The program product according to claim 14 wherein said method further comprises holding said updating in a suspension file in said data processing system until said where-used costs are approved.
